(19) United States
(12) Patent Application Publication
(10) Pub. No.: US 2006/0047540 A1
(43) Pub. Date: Mar. 2, 2006

(54) System and method for underwriting

(76) Inventors: Bruce Van Hutten, Chapin, SC (US); Steven Hobson, Lexington, SC (US); Chris Mercer, Columbia, SC (US)

Correspondence Address: MEYERTONS, HOOD, KIVLIN, KOWERT & GOETZEL, P.C., P.O. BOX 398, AUSTIN, TX, 78767-0398, US

(21) Appl. No.: 10/932,326

(22) Filed: Sep. 1, 2004

(51) Int. Cl. G06Q 40/00

(52) U.S. Cl. 705/4; 345/619

(57) ABSTRACT

In various embodiments, a user may graphically create and/or modify underwriting rules. The underwriting rules may be automatically executed by a computer system. Insurance information or insurance underwriting data stored on a database or received via an XML message may be processed automatically by the underwriting rules. Insurance claims or policies may be automatically accepted, declined, and/or referred by the underwriting rules.

### BACKGROUND OF THE INVENTION

1. Field of the Invention

The present invention generally relates to computer systems. In particular, embodiments relate to systems and methods of automatic underwriting for insurance claims and policies.

2. Brief Description of the Related Art

Underwriting is currently performed by a human underwriter. Often due to the volume of insurance claims and policies processed by an insurance company, several underwriters are necessary. Requiring a human underwriter to analyze every insurance policy application received by a company lengthens the application processing time. Insurance agents may have to wait to a long time for low risk applicants to be approved fro insurance policies due to the number of applications received by a human underwriter.

In addition, utilizing several different underwriters in an insurance company may cause inconsistencies on which policies and/or claims are accepted. Each underwriter may use different rules to determine whether to accept an insurance claim or write an insurance policy. Even when underwriters implement a similar set of rules, inconsistencies may arise as each underwriter applies the rules in a different manner. Property and casualty insurers may struggle with the highly manual, expensive, time consuming, and inefficient underwriting processes. Insurers may benefit from automation or partial automation of underwriting.

In the past, automated underwriting programs were limited to traditional computing architectures such as mainframes and stand-alone personal computers. It was necessary to install and maintain client systems in particular physical locations. Furthermore, underwriters could not easily modify the programs and usually required assistance from a software programmer or a person with knowledge of programming to edit the source code of the program and thus the underwriting rules. Insurers may benefit from an easily modifiable underwriting program.

### SUMMARY OF THE INVENTION

Herein we describe systems and methods for graphically creating underwriting rules that may automatically analyze insurance underwriting data or insurance information. Underwriting rules may include business rules, past experience, industry data, and/or risk analysis that determine whether to accept an insurance policy or insurance policy application. The underwriting rules may be created on a drawing tool or program. A user may use the drawing program to create a graphical model of one or more business rules used to underwrite insurance polices. The graphical model may be automatically converted into an executable insurance underwriting computer program. The underwriting computer program may apply the modeled underwriting rules to the analysis of insurance underwriting data. In some embodiments, analyzing insurance information includes receiving insurance information, accessing the insurance underwriting computer program, and automatically determining the underwriting status of the received insurance information using the insurance underwriting computer program. A report may be produced that includes the result of the analysis of insurance underwriting data or insurance information.

In some embodiments, a drawing tool or program may be accessed through a user system. A drawing tool may be stored on a memory of an insurance processing system and accessed via one or more Internet protocols, such as HTML or TCP/IP. The drawing tool may include one or more icons, toolbars, and/or viewable sections. A user may access a drawing tool to create underwriting rules via network protocols, such as the Internet. A drawing tool may be stored on a user system. A drawing tool may perform a modeling method that includes displaying one or more screens and/or one or more icons on a computer monitor. Icons may be positionable on the screens. Positioning one or more icons on at least one viewable section may create a graphical representation of underwriting rules. Connecting one or more icons may model the business rules process flow. In one embodiment, positioning one or more icons on one or more screens and forming one or more connections between the icons on the screens may form a graphical model.

In an embodiment, data sources may be associated with one or more icons. Data sources may include insurance information for analysis by the underwriting computer program. Data sources or insurance information may be received as an XML message or retrieved from a database on the insurance processing system or user system. Insurance information may be stored on a user system or insurance processing system.

In an embodiment, a graphical model may be automatically converted into an executable insurance underwriting computer program. A user may prepare a business rules document that includes computer readable data corresponding to modeled business rules. The computer readable data may be an XML language document, or fields in a database. The business rules document may be transmitted to an insurance processing system. The insurance processing system may convert the business rules document into an executable insurance underwriting computer program. A user may access the executable insurance underwriting computer program to analyze insurance information.

In one embodiment, a graphical model of one or more business rules may be modified after creation using the drawing program. A user may access an existing graphical model of business rules through a drawing tool. A user may then modify business rules by adding, deleting, or altering icons in the graphical model. The modified graphical model may then be converted into an executable insurance underwriting computer program.

In some embodiments, an insurance processing system may include a CPU and a memory coupled to the CPU. An insurance processing system memory may store programs that may be at least partially executed by the CPU of an insurance processing system. The program instructions may include receiving insurance information and processing the insurance information according to underwriting rules stored on a memory of an insurance processing system. Various embodiments may also include receiving or storing program instructions and/or data implemented upon a carrier medium.

### BRIEF DESCRIPTION OF THE DRAWINGS

Features and advantages of the methods and apparatus of the present invention will be more fully appreciated by reference to the following detailed description of presently preferred but nonetheless illustrative embodiments in accordance with the present invention when taken in conjunction with the accompanying drawings in which:

FIG. 1 depicts an illustration of a drawing tool used to create underwriting rules.

FIG. 2 depicts an illustration of a database worksheet.

FIG. 3 depicts an embodiment of an input window associated with a database icon.

FIG. 4 depicts an embodiment of an input window associated with a database or XML message icon.

FIG. 5 depicts an embodiment of an input window associated with XML message icon.

FIG. 6 depicts an illustration of a drawing tool used to create underwriting rules.

FIG. 7A depicts an illustration of a start icon.

FIG. 7B depicts an illustration of an end icon.

FIG. 7C depicts an illustration of an accept icon.

FIG. 7D depicts an illustration of a calculate icon.

FIG. 7E depicts an illustration of a calendar icon.

FIG. 7F depicts an illustration of a goto icon.

FIG. 8 depicts an embodiment of an input window associated with a decision icon.

FIG. 9 depicts an embodiment of an input window associated with a decision icon.

FIG. 10A depicts a flowchart of an embodiment of underwriting rules.

FIG. 10B depicts an embodiment of a worksheet including underwriting rules.

FIG. 11 depicts an embodiment of a window associated with debugging underwriting rules.

FIG. 12 depicts a flowchart of an embodiment for automatic underwriting.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION OF EMBODIMENTS

Herein we describe a system and method for the managing insurance claims and policies between a user system and an insurance processing system. For the purposes of this application, a claim refers to a demand for compensation for a loss, such as, but not limited to, medical treatment due to bodily injury, death of an insured, property damage, etc. In some embodiments, underwriting (i.e., whether to issue an insurance policy, etc.) may be automated using a computer system. Insurance information may be provided to the computer system via databases, XML messages, a user, and/or an insurance processing system. A computer system may automatically process the insurance information or insurance underwriting data using underwriting rules to produce an output or report. For example, insurance information such as driver's name, age, and driving record may be analyzed according to underwriting rules to determine whether to issue an insurance policy to the driver.

Underwriting rules may be a series or sequence of rules used to determine whether to accept an insurance policy. Underwriting rules may be based on business rules, past experience, industry data, and/or risk analysis. Underwriting may be automated to determine whether to accept, decline, or refer an insurance policy. Referring an insurance policy may include sending the report or output produced by the underwriting rules, the insurance information, and/or a message to a human underwriter that the policy requires for further analysis. In certain embodiments, a report may include detailed information on why a particular underwriting decision has been made. Underwriting may also be automated to determine under which type of insurance product an insurance applicant should be accepted. For example, underwriting rules may determine under which insurance product rating program or tier a policy application may be accepted.

It may be advantageous to first attempt to automatically determine whether an insurance claim or policy should be accepted. Automated underwriting may streamline the insurance application process, improve response time, and reduce the number of polices that need to be analyzed by a human underwriter. Reducing the number of policies that need to be analyzed by a human underwriter may reduce costs and allow human underwriting resources to be focused on unusual or difficult cases while allowing many policies to be analyzed automatically. Furthermore, improving response time may allow insurance companies to more quickly issue a policy and thus meet the needs of its clients more effectively. Automating underwriting may also improve consistency (e.g., insurance policies may be treated more similarly and subject to the same requirements).

In some embodiments, a computer system may automatically analyze insurance information based on underwriting rules. The computer system may be, but is not limited to, a user system, an insurance processing system, or a user system coupled to one or more other computer systems. The computer system may include a user system coupled to an insurance processing system. Wires, wide area networks (“WAN”), local area networks (“LAN”), and combinations thereof may couple a user system and an insurance processing system. A WAN may be a network that spans a relatively large geographical area. The Internet is an example of WAN. A WAN may include a variety of heterogeneous computer systems and networks that may be interconnected in a variety of ways and that may run a variety of software applications.

One or more LANs may be coupled to a WAN. A LAN may be a network that spans a relatively small area compared to a WAN. A LAN may be confined to a single building or group of buildings. Each node (e.g., user system, individual computer system or device) on a LAN may have its own CPU with which it may execute programs, and each node may also be able to access data and devices anywhere on a LAN. A LAN may allow many users to share devices (e.g., printers) and data stored on file servers. A LAN may be characterized by a variety of types of topology (e.g., the geometric arrangement of devices on the network), of protocols (e.g., the rules and encoding specifications for sending data, and whether the network uses a peer-to-peer or user/server architecture), and of media (e.g., twisted-pair wire, coaxial cables, fiber optic cables, and/or radio waves). A LAN may be coupled to other computer systems and/or other devices and/or other LANs through a WAN.

One or more mainframe computer systems may be coupled to a WAN. A mainframe may be coupled to a storage device or file server and mainframe terminals. An insurance processing system may include a combination of mainframes and/or mainframe terminals. Mainframe terminals may access data stored in the storage device or file server coupled to or included in a mainframe computer system. A user system may be a mainframe terminal.

A WAN may also include computer systems (e.g., user systems, insurance processing systems, etc.) connected to a WAN individually and not through a LAN. For example, WAN may include computer systems that may be geographically remote and connected to each other through the Internet.

A computer system (e.g., user systems, insurance processing systems, etc.) may also include a display device such as a monitor, an alphanumeric input device such as a keyboard, and a directional input device such as a mouse. A computer system may typically include components such as CPU with an associated memory such as floppy disks and/or CD-ROMs. Memory may store program instructions for computer programs. Program instructions may be executable by a CPU. The term “memory” is intended to include any installation medium, e.g., a CD-ROM or floppy disks, a computer system memory such as DRAM, SRAM, EDO RAM, Rambus RAM, etc., or any non-volatile memory such as a magnetic media, e.g., a hard drive or optical storage. Memory may also include other types of memory or combinations thereof. In addition, memory may be located in a first computer, which executes the programs or may be located in a second different computer, which connects to the first computer over a network. In the latter instance, the second computer may provide the program instructions to the first computer for execution. A computer system may take various forms such as a personal computer system, mainframe computer system, workstation, network appliance, Internet appliance, personal digital assistant (“PDA”), television system or other device. In general, the term “computer system” may refer to any device having a processor that executes instructions from a memory.

Computer system may be operable to execute computer programs to implement computer-implemented systems. It may be desirable to utilize a knowledge-based system for insurance claim processing which is configured to be accessed over the Internet or through a web browser, such as those described in the following applications, which are fully incorporated herein by reference as if set forth herein:

U.S. patent application Ser. No. 09/603,307 to Childress et al., entitled “SYSTEM AND METHOD FOR PROCESSING INSURANCE CLAIMS USING A TABLE OF CONTENTS” filed on Jun. 23, 2000;

U.S. patent application Ser. No. 09/603,129 to Jones, entitled “SYSTEM AND METHOD FOR IDENTIFYING CRITICAL FACTORS AFFECTING AN ESTIMATED VALUE INCLUDED IN AN INSURANCE CLAIM CONSULTATION REPORT” filed on Jun. 23, 2000;

U.S. patent application Ser. No. 09/603,662 to Childress, entitled “RELEVANCE CALCULATION FOR A REFERENCE SYSTEM IN AN INSURANCE PROCESSING SYSTEM” filed on Jun. 23, 2000;

U.S. patent application Ser. No. 09/603,308 to Wolfe et al., entitled “SYSTEM AND METHOD FOR EXTERNALIZATION OF FORMULAS FOR ASSESSING DAMAGES” filed on Jun. 23, 2000;

U.S. patent application Ser. No. 09/603,144 to Jones et al., entitled “SYSTEM AND METHOD FOR EXTERNALIZATION OF RULES FOR ASSESSING DAMAGES” filed on Jun. 23, 2000;

U.S. patent application Ser. No. 09/602,687 to Lorenz, entitled “WEB-ENABLED SYSTEM AND METHOD FOR ASSESSING DAMAGES” filed on Jun. 23, 2000;

PCT Patent Application No. PCT/US01/20030 to Jones et al., entitled “SYSTEM AND METHOD FOR PROCESSING INSURANCE CLAIMS” filed on Jun. 21, 2001;

U.S. patent application Ser. No. 09/603,302 to Childress, entitled “DYNAMIC HELP SYSTEM FOR AN INSURANCE PROCESSING SYSTEM” filed on Jun. 23, 2000;

U.S. patent application Ser. No. 09/602,691 to Childress, entitled “GRAPHICAL USER INTERFACE WITH A HIDE/SHOW FEATURE FOR A REFERENCE SYSTEM IN AN INSURANCE PROCESSING SYSTEM” filed on Jun. 23, 2000;

U.S. patent application Ser. No. 09/603,130 to Lorenz, entitled “RESET BUTTON FOR WEB-ENABLED SYSTEM AND METHOD FOR ASSESSING DAMAGES” filed on Jun. 23, 2000;

U.S. patent application Ser. No. 09/603,303 to Lorenz, entitled “INTERNET-ENABLED SYSTEM AND METHOD FOR ASSESSING DAMAGES” filed on Jun. 23, 2000;

U.S. patent application Ser. No. 09/603,304 to Lorenz, entitled “PRICING MODELS FOR WEB-ENABLED SYSTEM AND METHOD FOR ASSESSING DAMAGES” filed on Jun. 23, 2000;

U.S. patent application Ser. No. 09/603,306 to Wolfe, entitled “SYSTEM AND METHOD FOR DISPLAYING MESSAGES USING A MESSAGES TABLE” filed on Jun. 23, 2000;

U.S. patent application Ser. No. 10/422,632 to Wahlbin, entitled “GRAPHICAL INPUT DISPLAY IN AN INSURANCE PROCESSING SYSTEM” filed on Apr. 24, 2003;

U.S. patent application Ser. No. 10/422,450 to Wahlbin et al., entitled “METHOD AND SYSTEM FOR DETERMINING MONETARY AMOUNTS IN AN INSURANCE PROCESSING SYSTEM” filed on Apr. 24, 2003;

U.S. patent application Publication No. 2004-0054557 published on Mar. 18, 2004 to Wahlbin et al., entitled “COMPUTERIZED METHOD AND SYSTEM FOR ESTIMATING PREMISES LIABILITY FOR AN ACCIDENT” filed on Sep. 9, 2002;

U.S. patent application Publication No. 2004-0054558 published on Mar. 18, 2004 to Wahlbin et al., entitled “COMPUTERIZED METHOD AND SYSTEM FOR DETERMINING CLAIMANT STATUS IN PREMISES LIABILITY FOR AN ACCIDENT” filed on Sep. 9, 2002;

U.S. patent application Publication No. 2004-0049409 published on Mar. 11, 2004 to Wahlbin et al., entitled “COMPUTERIZED METHOD AND SYSTEM FOR DETERMINING BREACH OF DUTY IN PREMISES LIABILITY FOR AN ACCIDENT” filed on Sep. 9, 2002;

U.S. patent application Publication No. 2004-0054556 published on Mar. 18, 2004 to Wahlbin et al., entitled “COMPUTERIZED METHOD AND SYSTEM FOR DETERMINING CAUSATION IN PREMISES LIABILITY FOR AN ACCIDENT” filed on Sep. 9, 2002;

U.S. patent application Publication No. 2004-0054559 published on Mar. 18, 2004 to Wahlbin et al., entitled “COMPUTERIZED METHOD AND SYSTEM FOR DETERMINING THE CONTRIBUTION OF DEFENSES TO PREMISES LIABILITY FOR AN ACCIDENT” filed on Sep. 9, 2002;

U.S. patent application Publication No. 2002-0069091 published on Jun. 6, 2002 to Wahlbin et al., entitled “COMPUTERIZED METHOD OF LIABILITY ASSESSMENT FOR AN ACCIDENT” filed on Oct. 2, 2001;

U.S. patent application Publication No. 2002-0082873 published on Jun. 27, 2002 to Wahlbin et al., entitled “COMPUTERIZED METHOD AND SYSTEM OF DETERMINING RIGHT OF WAY AND LIABILITY FOR AN ACCIDENT” filed on Oct. 2, 2001;

U.S. patent application Publication No. 2002-0062234 published on May 23, 2002 to Wahlbin et al., entitled “COMPUTERIZED METHOD AND SYSTEM OF ESTIMATING LIABILITY AND RANGE OF LIABILITY FOR AN ACCIDENT” filed on Oct. 2, 2001;

U.S. patent application Publication No. 2002-0055860 published on May 9, 2002 to Wahlbin et al., entitled “COMPUTERIZED METHOD AND SYSTEM OF DETERMINING RIGHT OF WAY IN AN ACCIDENT” filed on Oct. 2, 2001;

U.S. patent application Publication No. 2002-0062233 published on May 23, 2002 to Wahlbin et al., entitled “COMPUTERIZED METHOD AND SYSTEM OF ASSESSING LIABILITY FOR AN ACCIDENT USING IMPACT GROUPS” filed on Oct. 2, 2001;

U.S. patent application Publication No. 2002-0059097 published on May 16, 2002 to Wahlbin et al., entitled “COMPUTERIZED METHOD AND SYSTEM OF ASSIGNING AN ABSOLUTE LIABILITY VALUE FOR AN ACCIDENT” filed on Oct. 2, 2001;

U.S. patent application Publication No. 2002-0087363 published on Jul. 4, 2002 to Wahlbin et al., entitled “COMPUTERIZED METHOD AND SYSTEM OF LIABILITY ASSESSMENT FOR AN ACCIDENT USING ENVIRONMENTAL, VEHICLE, AND DRIVER CONDITIONS AND DRIVER ACTIONS” filed on Oct. 2, 2001;

U.S. patent application Publication No. 2002-0091504 published on Jul. 11, 2002 to Wahlbin et al., entitled “COMPUTERIZED METHOD AND SYSTEM FOR ACCUMULATING LIABILITY ESTIMATES” filed on Oct. 2, 2001;

U.S. patent application Publication No. 2002-0128881 published on Sep. 12, 2002 to Wahlbin et al., entitled “COMPUTERIZED METHOD AND SYSTEM FOR ADJUSTING LIABILITY ESTIMATES IN AN ACCIDENT LIABILITY ASSESSMENT PROGRAM” filed on Oct. 2, 2001;

U.S. patent application Publication No. 2002-0062232 published on Sep. 12, 2002 to Wahlbin et al., entitled “COMPUTERIZED METHOD AND SYSTEM FOR ADJUSTING LIABILITY ESTIMATION FACTORS IN AN ACCIDENT LIABILITY ASSESSMENT PROGRAM” filed on Oct. 2, 2001;

U.S. patent application Publication No. 2002-0062235 published on May 23, 2002 to Wahlbin et al., entitled “COMPUTERIZED METHOD AND SYSTEM FOR PROVIDING CLAIMS DATA TO AN ACCIDENT LIABILITY ASSESSMENT PROGRAM” filed on Oct. 2, 2001;

U.S. patent application Publication No. 2002-0059084 published on May 16, 2002 to Wahlbin et al., entitled “COMPUTERIZED METHOD AND SYSTEM OF DISPLAYING AN ACCIDENT TYPE” filed on Oct. 2, 2001;

U.S. patent application Publication No. 2002-0059086 published on May 16, 2002 to Wahlbin et al., entitled “COMPUTERIZED METHOD AND SYSTEM OF DISPLAYING A ROADWAY CONFIGURATION RELATING TO AN ACCIDENT” filed on Oct. 2, 2001;

U.S. patent application Publication No. 2002-0059087 published on May 16, 2002 to Wahlbin et al., entitled “:COMPUTERIZED METHOD AND SYSTEM OF DISPLAYING AN IMPACT POINT RELATING TO AN ACCIDENT” filed on Oct. 2, 2001;

U.S. patent application Publication No. 2002-0059083 published on May 16, 2002 to Wahlbin et al., entitled “COMPUTERIZED METHOD AND SYSTEM OF DETERMINING INCONSISTENCIES IN WITNESS STATEMENTS RELATING TO AN ACCIDENT” filed on Oct. 2, 2001;

U.S. patent application Publication No. 2002-0049619 published on Apr. 25, 2002 to Wahlbin et al., entitled “COMPUTERIZED METHOD AND SYSTEM OF IDENTIFYING A CREDIBLE WITNESS STATEMENT RELATING TO AN ACCIDENT” filed on Oct. 2, 2001;

U.S. patent application Publication No. 2002-0059085 published on May 16, 2002 to Wahlbin et al., entitled “COMPUTERIZED METHOD AND SYSTEM OF DETERMINING A CREDIBLE REAL SET OF CHARACTERISTICS FOR AN ACCIDENT” filed on Oct. 2, 2001;

U.S. patent application Publication No. 2004-0103008 published on May 27, 2004 to Wahlbin et al., entitled “COMPUTERIZED METHOD AND SYSTEM FOR ESTIMATING LIABILITY FOR AN ACCIDENT FROM AN INVESTIGATION OF THE ACCIDENT” filed on Nov. 27, 2002;

U.S. patent application Publication No. 2004-0111301 published on Jun. 6, 2004 to Wahlbin et al., entitled “COMPUTERIZED METHOD AND SYSTEM FOR ESTIMATING LIABILITY FOR AN ACCIDENT USING DYNAMIC GENERATION OF QUESTIONS” filed on Nov. 27, 2002;

U.S. patent application Publication No. 2004-0103010 published on May 27, 2004 to Wahlbin et al., entitled “COMPUTERIZED METHOD AND SYSTEM FOR ESTIMATING AN EFFECT ON LIABILITY OF THE SPEED OF VEHICLES IN AN ACCIDENT AND TIME AND DISTANCE TRAVELED BY THE VEHICLES” filed on Nov. 27, 2002;

U.S. patent application Publication No. 2004-0103004 published on May 27, 2004 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES IN AN ACCIDENT AND TIME AND DISTANCE TRAVELED BY THE VEHICLES IN A MERGING VEHICLE ACCIDENT” filed on Nov. 27, 2002;

U.S. patent application Publication No. 2004-0103006 published on May 27, 2004 to Wahlbin et al., entitled “COMPUTERIZED METHOD AND SYSTEM FOR ESTIMATING AN EFFECT ON LIABILITY USING A COMPARISON OF THE ACTUAL SPEED OF VEHICLES WITH A SPECIFIED SPEED” filed on Nov. 27, 2002;

U.S. patent application Publication No. 2004-0102985 published on May 27, 2004 to Wahlbin et al., entitled “COMPUTERIZED METHOD AND SYSTEM FOR ESTIMATING AN EFFECT ON LIABILITY BASED ON THE STOPPING DISTANCE OF VEHICLES” filed on Nov. 27, 2002;

U.S. patent application Publication No. 2004-0103007 published on May 27, 2004 to Wahlbin et al., entitled “COMPUTERIZED METHOD AND SYSTEM FOR ESTIMATING AN EFFECT ON LIABILITY USING CLAIM DATA ACCESSED FROM CLAIM REPORTING SOFTWARE” filed on Nov. 27, 2002;

U.S. patent application Publication No. 2004-0103009 published on May 27, 2004 to Wahlbin et al., entitled “COMPUTERIZED METHOD AND SYSTEM FOR CREATING PRE-CONFIGURED CLAIM REPORTS INCLUDING LIABILITY IN AN ACCIDENT ESTIMATED USING A COMPUTER SYSTEM” filed on Nov. 27, 2002;

U.S. patent application Publication No. 2004-0102984 published on May 27, 2004 to Wahlbin et al., entitled “COMPUTERIZED METHOD AND SYSTEM FOR ESTIMATING LIABILITY USING RECORDED VEHICLE DATA” filed on Nov. 27, 2002;

U.S. patent application Publication No. 2004-0103005 published on May 27, 2004 to Wahlbin et al., entitled “COMPUTERIZED METHOD AND SYSTEM FOR ESTIMATING MONETARY DAMAGES DUE TO INJURIES IN AN ACCIDENT FROM LIABILITY ESTIMATED USING A COMPUTER SYSTEM” filed on Nov. 27, 2002;

U.S. patent application Ser. No. 10/790,632 to Woods et al., entitled “SYSTEMS AND METHODS FOR A GRAPHICAL INPUT DISPLAY IN AN INSURANCE PROCESSING SYSTEM” filed on Mar. 1, 2004;

U.S. patent application Ser. No. 10/790,626 to Lorenz, entitled “SYSTEMS AND METHODS FOR USING DATA STRUCTURE LANGUAGE IN WEB SERVICES” filed on Mar. 1, 2004;

U.S. patent application Ser. No. 10/786,572 to Osborne, entitled “SYSTEMS AND METHODS FOR PRINTING AN INSURANCE DOCUMENT” filed on Feb. 25, 2004; and

U.S. patent application Ser. No. 10/838,159 to Van Hutten et al., entitled “SYSTEM AND METHOD FOR CAPTURING AN IMAGE” filed on May 3, 2004.

A knowledge-based system for an insurance processing system that includes underwriting may be accessed over the Internet or through a web browser and may provide a web-enabled method and system for processing and/or underwriting insurance policies. The insurance processing system may include a rules engine and a web server that is coupled to the rules engine. The rules engine may be configured to generate a plurality of insurance policy assessment questions. The web server may be configured to generate a plurality of web pages comprising the insurance policy assessment questions. The insurance processing system may further include a web browser that is configured to receive the plurality of web pages comprising the insurance policy assessment questions from the web server. The web browser may then be configured to display the plurality of web pages comprising the insurance policy assessment questions. The web browser may then be configured to receive insurance policy assessment data entered by a user in response to the insurance policy assessment questions during an insurance policy consultation session and send the insurance policy assessment data to the web server. In one embodiment, the web server is further configured to receive the insurance policy assessment data from the web browser and send the insurance policy assessment data to the rules engine.

The rules engine may be further configured to estimate a policy price of an insurance policy as a function of the insurance policy assessment data. The rules engine may be further configured to send the estimate of the policy price of the insurance policy to the web browser through the web server. The web browser may be further configured to display the estimate of the policy price of the insurance policy received from the rules engine through the web server. In one embodiment, the web server and web browser are located on separate computer systems that are communicatively coupled through a network. In another embodiment, the web server and web browser may be located and executed on a single computer system.

The insurance processing system may further include adapter software that is configured to enable communication between the rules engine and the web server. The adapter software may include one or more dynamic link libraries.

In one embodiment, the insurance processing system may further include a plurality of web browsers corresponding respectively to a plurality of users. Each of the web browsers may be configured to receive one or more of the plurality of web pages comprising the insurance policy assessment questions from the web server, display the received web pages comprising the insurance policy assessment questions, receive insurance policy assessment data entered by one of a plurality of users in response to the insurance policy assessment questions during one of a plurality of insurance policy consultation sessions, and send the insurance policy assessment data to the web server or insurance processing system.

In one embodiment, a method for developing a web-enabled insurance processing system may include providing a rules engine. The rules engine maybe configured to estimate a price of an insurance policy as a function of insurance policy assessment data entered by a user in response to insurance policy assessment questions. The method may further include providing a web server capable of generating a plurality of web pages that are viewable by a web browser. The method may further include wrapping the rules engine with a component interface in accordance with a component architecture specification. The component interface may include one or more definitions of methods of communication between the rules engine and the web server, wherein the methods of communication are operable to transmit the insurance claim assessment data from the web server to the rules engine and operable to transmit the insurance policy assessment questions from the rules engine to the web server. The component architecture specification may include a Component Object Model (COM) specification.

In some embodiments, a user may interact with an insurance processing system through the Internet. Users may also communicate with an insurance processing system through other networks. In some embodiments, a data structure language (e.g., XML, Web Service Description Language (WSDL), and/or other markup languages (e.g., hyper text markup language (HTML)) may be used for communications between a user and an insurance processing system. In some embodiments, WSDL may define an interface for a web service including available operations, the protocol that the user should use to invoke the web service, and the type of data the web service expects.

In one embodiment, a user system may access, manage, and/or create insurance policies. Insurance companies may offer several types of insurance products. An insurance policy may include, but is not limited to, automobile insurance, workman's compensation insurance, life insurance, annuities, property insurance, liability insurance, malpractice insurance, and/or commercial package polices. Insurance products may include multiple rating schedules including, but not limited to, standard, sub-standard, and/or premium. Rating schedules may affect insurance premiums. An insurance policy may be issued to at least one entity, such as a corporation, a limited liability company, a limited liability partnership, a limited partnership, a general partnership, a sole proprietorship, or an individual.

A user may determine whether to accept/renew, or decline an insurance policy based on underwriting rules. Underwriting rules may include, but are not limited to, a sequence of steps in which information about an entity may be evaluated to determine whether to accept an insurance claim or policy and/or under which insurance product an insurance policy may be accepted. Underwriting rules may be based on business rules, experience in the industry, and/or statistics. Underwriting rules may be programmed on a computer system. The computer system may execute the underwriting rules or apply the underwriting rules to a given set of data. In an embodiment, insurance information provided by a user may be analyzed automatically by the computer system using the underwriting rules.

In some embodiments, a user may access a drawing tool or program capable of creating underwriting rules through a computer system. A drawing tool or program may be, but is not limited to, any program capable of diagramming, flowcharting, and/or creating graphical representations of rules. In an embodiment, a drawing tool may at least include Microsoft Visio, commercially available from Microsoft Corporation, or a similar program. A drawing tool may be capable of executing underwriting rules or applying the underwriting rules to data in a database or a XML message. The drawing tool may run at least partially on the user system. In an embodiment, the drawing tool may be on an insurance processing system accessible via the Internet. The drawing tool may be accessed via a webpage.

In some embodiments, a user may not need to have knowledge of programming or source code to create underwriting rules with the drawing tool. By removing reliance on skilled programmers the underwriting rules may be changed as often as necessary or desired by underwriters or an insurance company. Allowing underwriters to easily modify underwriting rules with a drawing tool, rather than requiring an underwriter to contact a programmer who, in turn, will change the source code of the program, may allow an insurance company to more quickly respond to changing risks or industry standards or regulations. Insurance companies may benefit from reduced lag times between when a change in underwriting rules is desired and when the change can be implemented.

The drawing tool may include Microsoft Visio or another program capable of creating flowcharts. A user may be able to create and/or edit underwriting rules in the graphical interface without having to manually change the source code. A user may manipulate icons in the drawing tool to alter underwriting rules. By manipulating icons in the drawing tool, the program or subroutines or a program associated with the icons in the drawing tool may be changed automatically. A drawing tool may automatically detect errors or inconsistencies caused by manipulating underwriting rules and require users to resolve the errors.

A drawing tool may include applications or subroutines executable in another program. In an embodiment, a user may access plug-ins, add-ins, applications, and/or subroutines for the drawing tool via an insurance processing system. An application configured to provide customized icons and/or shapes may be included in a drawing tool. For example, an application used in conjunction with Microsoft Visio may provide additional icons useable in Microsoft Visio. A drawing tool may be configured such that icons or images in a drawing tool may correspond to programs or subroutines. Icons may be coupled to create a series of subroutines or steps that may be used to analyze or process data.

A drawing tool may include a subroutine and/or a program that includes one or more templates. Templates may include icons for a toolbar and/or a program that facilitates creation of custom icons. Templates may include a customizable example of underwriting rules in graphical form. In an embodiment, a template may include a worksheet that includes common steps in underwriting rules, such as: what is the applicant's gender, what is the applicant's age, what is the applicant's credit score, and/or does the applicant have other insurance policies with the company. A drawing tool may include a subroutine and/or a program that substantially debugs a program. A drawing tool may include a subroutine and/or a program that executes graphically represented underwriting rules.

A drawing tool may be configured such that rules created on a drawing tool may be accessed by an insurance processing system. In certain embodiments, a graphically represented underwriting rules set may be transmitted to an insurance processing system. The graphical model of underwriting rules may be automatically converted into an executable insurance underwriting computer program. The graphical model may be automatically converted into an executable insurance underwriting computer program at least partially on the user system. In one embodiment, the graphical model may be automatically converted into an executable insurance underwriting computer program at least partially on the insurance processing system. The underwriting computer program may apply the modeled underwriting rules to the analysis of insurance information or underwriting data. An insurance processing system may access rules created on a drawing tool and store the rules in a memory or database of the insurance processing system. A user may then be able to access the underwriting rules via an insurance processing system. A user may be able to process the insurance information or insurance underwriting data using the underwriting rules. The rules may be at least partially executable on the insurance processing system. Insurance information from a user system may be analyzed using underwriting rules on an insurance processing system. Insurance information from a database and/or XML messages may be analyzed using the underwriting rules by the insurance processing system.

A drawing tool may include one or more viewable sections and/or toolbars. A viewable section may include, but is not limited to, a portion, a section, and/or a window in the drawing tool. A viewable section may include a worksheet. In an embodiment, a drawing tool may include a plurality of worksheets. A user may view one or more of the viewable sections concurrently. A user may view one viewable section and then select a tab or link to view another viewable section.

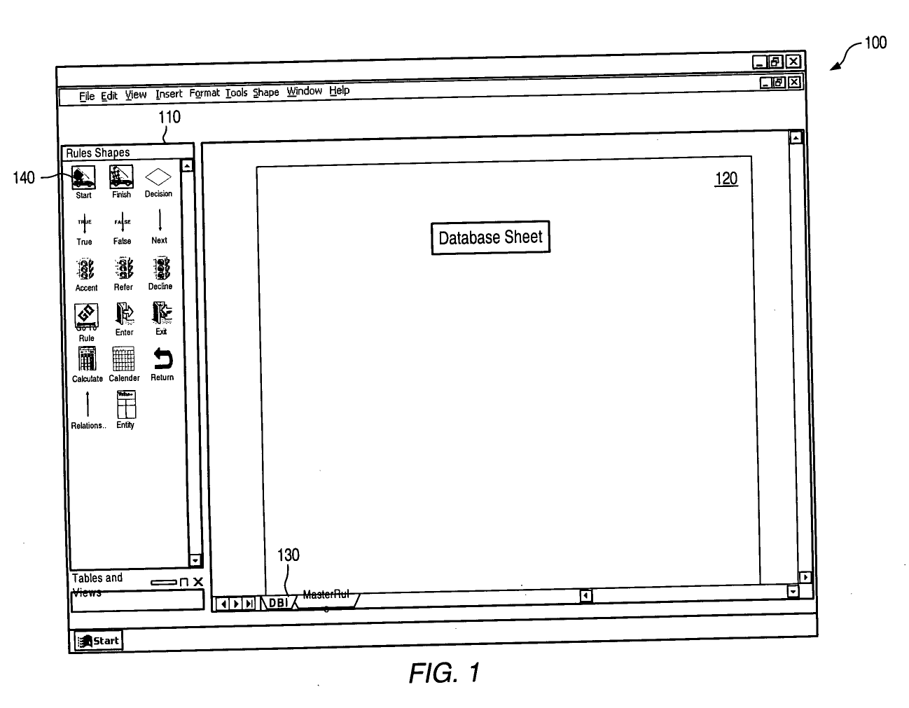

In some embodiments, the drawing tool 100 may include one or more toolbars 110 and a viewable section 120, as depicted in FIG. 1. The drawing tool may include a plurality of viewable sections. In an embodiment, all viewable sections may not be viewable at a given time. A user may view one or more viewable sections using one or more links associated with a viewable section and positioned in the drawing tool. One or more toolbars may be positioned proximate one or more viewable sections.

In some embodiments, the toolbar 110 may include one or more links 130. Links 130 may be configured to open a desired worksheet 120, database, and/or portion of a memory. In some embodiments, links to references may be included on a toolbar. For example, a link to the New York Insurance Manual may be included for access by a user creating underwriting rules. As another example, a company's standard operating procedures may be linked. Links to references may facilitate creation of underwriting rules for an industry and/or entity. For example, a state may have regulations concerning insurance underwriting; it may be helpful for a user to be able to reference regulations concerning underwriting while creating underwriting rules in a drawing tool.

In some embodiments, the toolbar 110 may include one or more icons 140, as depicted in FIG. 1. One or more icons 140 may be positionable in a viewable section 120 of a drawing tool 100. A plurality of icons may be used to create underwriting rules. A plurality of icons may graphically depict underwriting rules. An icon may be a shape, a line, an image, characters, numbers, and/or combinations thereof. An icon may have a shape similar to a square, rectangle, parallelogram, circle, oval, and/or an irregular shape. An icon may have a shape similar to a traffic signal, a car, a flag, an arrow, a door, a calculator, a portion of a calendar, and/or combinations thereof. An icon may include a variety of colors. For example, an icon may be a traffic signal with one or more red lights.

In some embodiments, an icon may be associated with a subroutine or program. In certain embodiments, an icon may be associated with a step of an underwriting rule set and/or a portion of a step of an underwriting rule set. The icon subroutine may perform a function including, but not limited to, comparing, calculating, etc. Functions also may include, but are not limited to, controlling the number of times a rule sequence runs, starting a rule sequence, ending a rule sequence, coupling icons, comparing items, going to another icon, counting, building totals, performing mathematical equations/calculations, calculating the difference between dates, retrieving data from a database, receiving XML messages, accepting an insurance claim or policy, declining an insurance policy, and/or referring an insurance policy.

In some embodiments, selecting an icon and positioning the icon in a viewable window may couple a subroutine associated with the icon to the template program associated with the viewable window. For example, positioning a plurality of icons on the viewable section may create a program and the program may be configured to apply the underwriting rules graphically represented by the icons to insurance information. The created program may automatically retrieve insurance information or insurance underwriting data from a database and analyze the insurance information in the database according to the graphically represented underwriting rules.

Positioning an icon in a viewable window may cause an input window to open. An input window may allow a user to associate a function with an icon. An input window may be a template with one or more fields. In certain embodiments, fields of a template may include a choice of options from which a user may select an item for the field. A user may be able to manually enter an item in a field. An input window may include a field associated with the name displayed in the viewable window proximate the icon. For example, a user may enter ‘Gender’ in the name field of the input window. The word ‘Gender’ may appear proximate the associated icon on the viewable window.

In some embodiments, a user may open a drawing tool to create underwriting rules capable of automatically processing insurance application information. A drawing tool may include one or more viewable sections and one or more toolbars. Toolbars may include a plurality of icons. In certain embodiments, a user may be able to create icons for use in underwriting rules. For example, a user may be able to create an icon to perform a desired function. By allowing a user to custom create icons, underwriting rules may be tailored to meet the needs of a particular industry or company.

A step of preparing a set of underwriting rules may include accessing and/or receiving insurance information. In an embodiment, insurance information may be sent to a computer system, such as an insurance processing system or a user system, for analysis by underwriting rules. In certain embodiments, a data transformer may translate insurance information into a format suitable for analysis by the underwriting rules. An icon in a drawing tool may be configured to access insurance information stored on a memory, database, and/or repository of a computer system. In an embodiment, insurance information may be stored on a memory of an insurance processing system.

An icon in a drawing tool may be configured to receive insurance information. An icon may be configured to receive XML messages. In an embodiment, XML messages including insurance information or underwriting data may be sent from a user to an insurance processing system and the insurance processing system analyzes the XML message according to underwriting rules.

A drawing tool may include a viewable section that may link a database or XML message with the underwriting rules and/or drawing tool, such that the database or XML message may be accessed by the underwriting rules. The database may be open database connectivity (ODBC) compliant. In certain embodiments, underwriting rules created in a drawing tool may access databases and/or XML messages linked to a viewable section. In an embodiment, a single database or XML message may be linked to a single viewable section. A plurality of databases and/or XML messages may be linked to a single viewable section. To insert a link to a database or XML message in a viewable section, a user may use a feature of the drawing tool to link a database or XML message to a shape. A user may insert links to databases using a reverse engineering tool available in the drawing tool. In an embodiment, a user may use a database wizard in Microsoft Visio to couple a database or XML message to a shape. A user may link the drawing tool to a database located on an insurance processing system and/or user system.

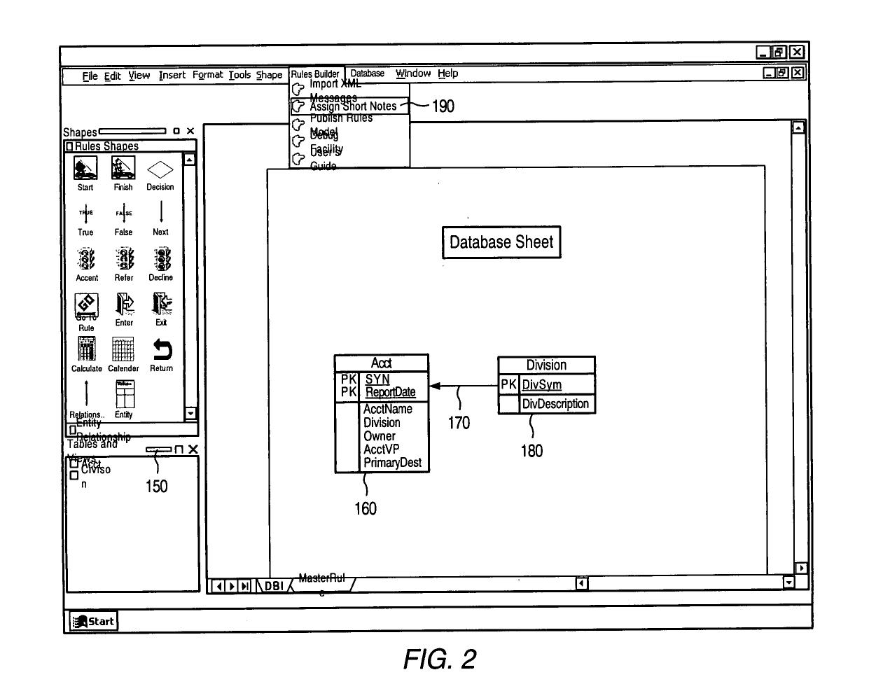

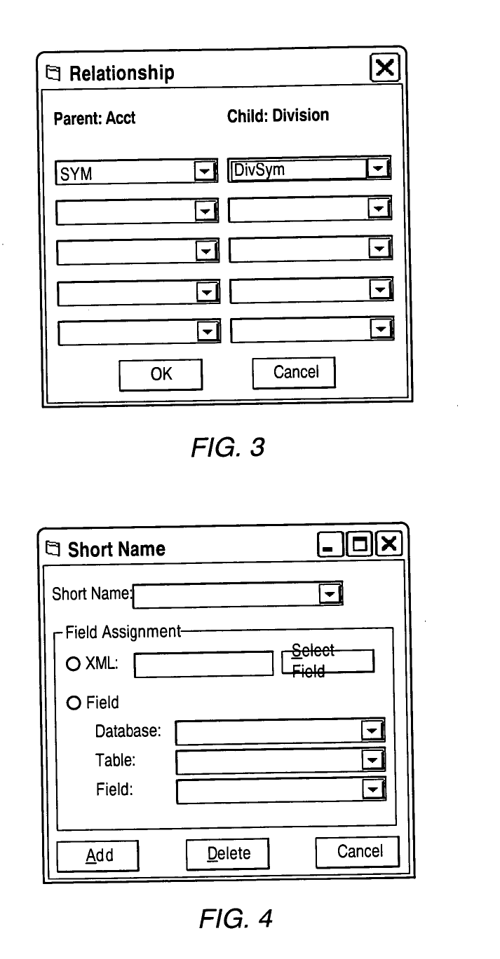

In some embodiments, a toolbar 150 including all linked databases and/or XML messages may be included in the drawing tool, as depicted in FIG. 2. An entity relationship toolbar including icons for linking sections of a database and/or XML message may be included in a drawing tool. In an embodiment, an entity relationship tool bar may include icons that couple and/or establish a relationship between fields of a database and/or XML message. A first field 160 may be coupled with a coupling icon 170 to a second field 180. An icon may be used to establish a parent-category relationship between one or more fields of a database. A user may be prompted to enter the type of relationship between fields of a database and/or XML message when coupling one or more icons representing fields of a database and/or XML message. As depicted in FIG. 3, a prompt may allow a user to enter the type of relationship that exists between coupled icons.

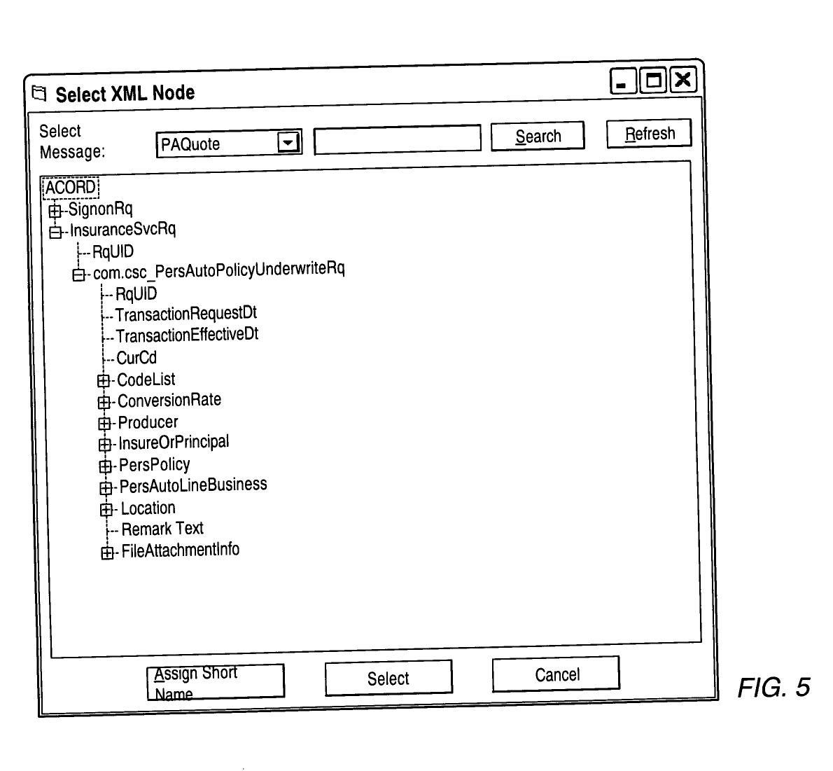

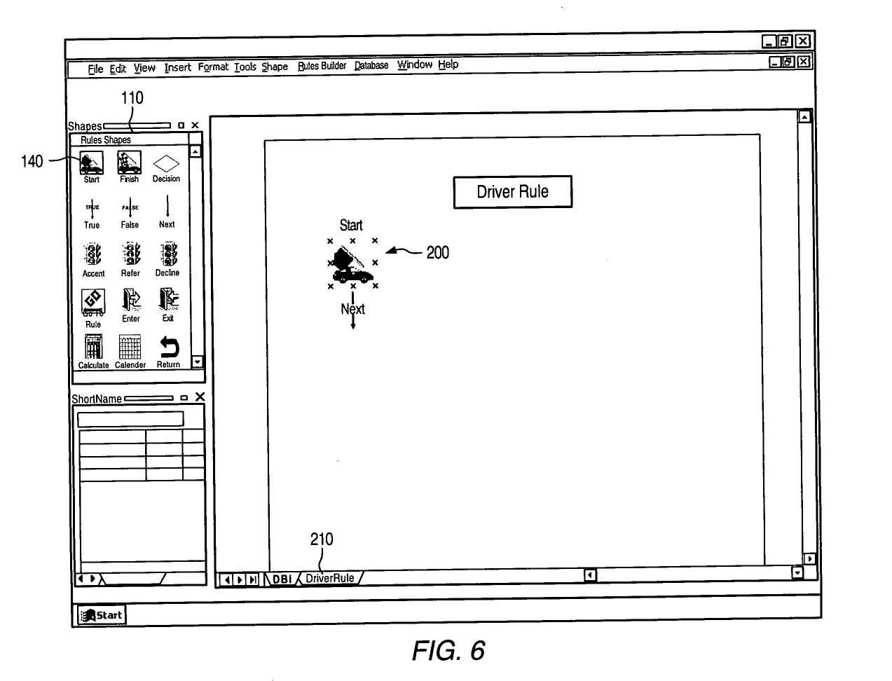

In some embodiments, a user may change a name of an icon associated with a database and/or XML message. A user may change a name of an icon to a name descriptive of the contents of a database and/or XML message. In an embodiment, a user may select a command 190 or link on a drawing tool to assign a name to an icon coupled to a database and/or XML message. See FIG. 2. As depicted in FIG. 4, a short name prompt may allow a user to assign a new name for an icon associated with a database and/or XML message. The short name prompt may include one or more fields including a field to enter a name that will be assigned to the database or XML message and/or one or more fields to enter which portion of a database or XML message will be assigned the entered name. In some embodiments, a short name prompt may automatically display database and/or XML options for a user to select. For example, a short name prompt may include drop down menus so that a user may select which database should be coupled with an entered name. A short name prompt in which a user may assign a new name to an XML message may also allow a user to select the appropriate node of an XML message to name by browsing through a detailed view of an XML message. FIG. 5 depicts an embodiment of a detailed tree view of an XML message.

In some embodiments, a user may create underwriting rules or a set of underwriting rules on one or more viewable sections of a drawing tool. It may be desirable to create underwriting rules so that the graphical representation of the underwriting rules may be simple and easy to follow and/or understand. It may be easier for an underwriter to create common sections of underwriting rules in different windows and link them to a main branch of graphically represented underwriting rules. A rules viewable section may include the created underwriting rules. A rules viewable section may include links databases and/or XML messages. In certain embodiments, underwriting rules are created on a different viewable section than the viewable section which links to databases and/or XML messages are established.

One or more rules templates may be available on a drawing tool. A rules template may be customizable. A rules template may facilitate entry of underwriting rules. In an embodiment, a rules template may include common underwriting rules for an industry and/or entity. Icons may be deleted and/or added to a rules template. Values for icons may be altered in a rules template. In an embodiment, a rules template may be configured such that a desired output may be produced as a default. For example, an underwriting rules template may be preset to return an output of accept policy, such that unless the underwriting rules declines or refers an insurance policy, the insurance policy will be accepted. In some embodiments, a drawing tool may automatically open a template in a rules viewable section.

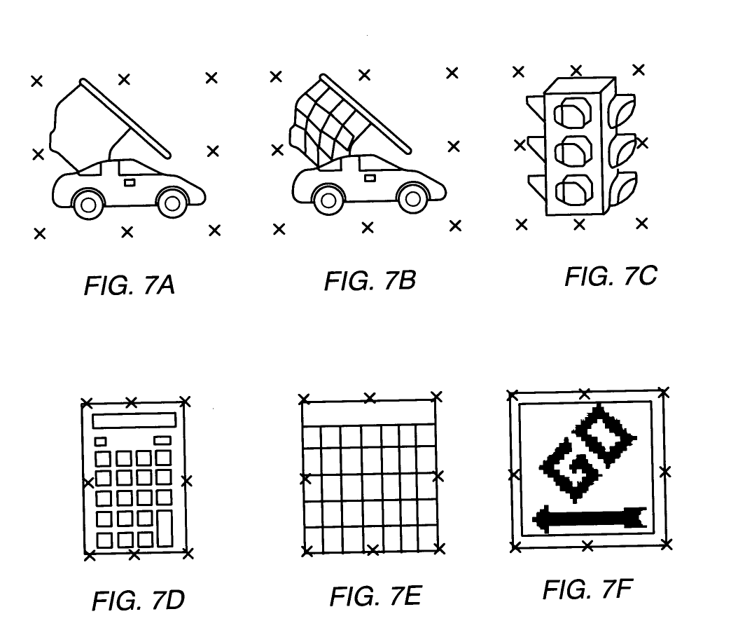

FIG. 6 depicts an embodiment of a rules viewable section. In some embodiments, a user may select icons 140 from a plurality of icons on a toolbar 110 to position 200 on a rules viewable section 210. For example, a user may drag and drop an icon 140 from a toolbar 110 into a viewable section 210. In an embodiment, a user may select icons 140 from a toolbar 110 and position the icons on one or more worksheets 210 in a drawing tool to create underwriting rules.

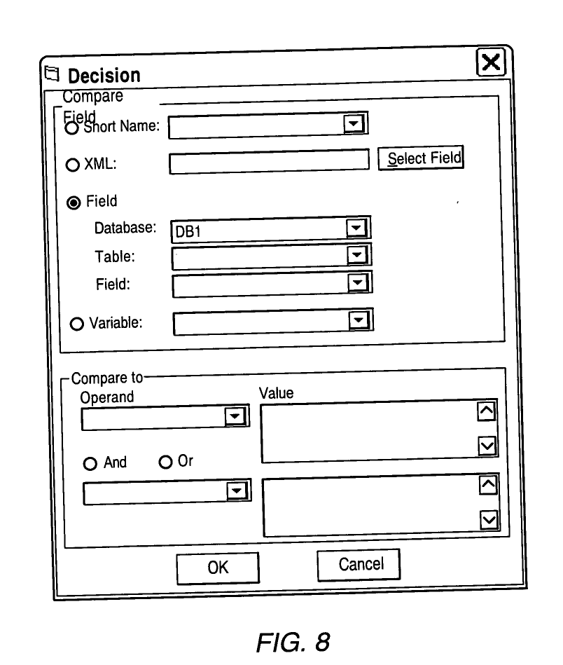

A shape and/or color of an icon may be descriptive of the icon's function. For example, FIG. 7A depicts an embodiment of a start icon. A start icon may indicate the first step of underwriting rules. A start icon may have a shape that is descriptive of the function, such as a car with a start flag.

FIG. 7B depicts an embodiment of an end icon. An end icon may be coupled to underwriting rules such that it is the last icon in the series of underwriting rules and ends the execution of the underwriting rules. An end icon may be configured to produce a report and/or an output. A report and/or an output may include information such as, but not limited to, whether a claim or policy is accepted, declined, or referred to a human underwriter. In some embodiments, an end icon may trigger a default output. For example, if insurance information is processed by a set of underwriting rules and the end icon is reached, an insurance claim or policy may be automatically accepted unless the underwriting rules have determined otherwise.

FIG. 7C depicts an embodiment of an output icon. An output icon may be depicted as a traffic signal. An output icon may represent a business decision. An output icon may be associated with accepting, declining, and/or referring an insurance policy. In some embodiments, a refer output icon may refer the insurance policy to another sequence of underwriting rules executable by a computer system. An output icon may be used to indicate under which insurance products an applicant may be accepted. For example, an output icon may indicate acceptance of an applicant and may also indicate that the policy application should be rated as a premium automobile insurance policy. A traffic signal icon with one or more green lights may represent acceptance of a policy. A traffic signal with one or more yellow lights may automatically refer an insurance policy to a human underwriter. A traffic signal with one or more red lights may represent automatically declining an insurance policy. Output icons, such as traffic signal outputs, may be coupled to underwriting rules such that a decision to accept, decline, or refer an insurance claim or policy may be automatically made using the underwriting rules. Output icons may be coupled to underwriting rules at positions when a decision can be automatically made. For example, a user may create underwriting rules that automatically decline insurance policies to individuals with more than one driving under the influence (DUI) or driving while intoxicated (DWI) conviction. When underwriting rules process an insurance policy application and determines that an applicant has more than one DUI or DWI conviction, the underwriting rules may automatically decline the policy. A user may couple an output icon associated with declining policies, such as a traffic signal with one or more red lights, to the icon that determines whether an applicant has more than one DUI or DWI conviction.

FIG. 7D depicts an embodiment of a calculating icon capable of performing calculations. A calculating icon may have a shape similar to a calculator. A calculating icon may be used to indicate performing simple and/or complex calculations. Insurance information may be processed using the calculating icon in underwriting rules. A calculating icon may be capable of counting. For example, a calculating icon may analyze insurance information for the number of DUI or DWI convictions, the number of accidents, and/or the number of cars insured. A variety of other portions of insurance information may be counted. A calculating icon may also be used to calculate if a policy is still in effect. A calculating icon may be used to calculate if a longevity or other discount may apply to a policy price, such as a 5% deduction for maintaining the policy for more than 10 years. FIG. 7E depicts another embodiment of a calculating icon, shaped like a calendar page. A calendar shaped icon may allow differences between dates to be calculated. A calculating icon may calculate an applicant's age, an age of a policy, and/or other differences between dates.

In some embodiments, since it may be desirable to create underwriting rules on more than one worksheet or viewable section, underwriting rules may include icon representing a step that directs the flow of logic from one rule to another rule. FIG. 7F depicts an embodiment of a goto icon. A goto icon may direct a flow of logic to another rule, step of underwriting rules, an icon, or a viewable section. It may desirable to use goto icons to direct the flow of logic to a rule only applicable when certain conditions are met. For example, business rules may dictate that drivers under 25 years old be analyzed by more stringent underwriting rules than drivers over 25 years old. A goto icon may direct the flow of logic to a more stringent set of underwriting rules when underwriting rules determine that an applicant's age is less than 25. After a flow of logic completes the rule or rules that a goto icon has directed the logic, the flow of logic may return to the original set of underwriting rules or end. An icon may direct the flow of logic back to the original set of underwriting rules. A goto icon may be useful to a user creating underwriting rules when several different conditions may require insurance information to be analyzed by a single rule or set of rules. For example, drivers under 18, drivers with one DWI conviction, and drivers with credit ratings under a certain range may be subject to an alternative set of rules while drivers that do not meet any of these conditions may not be subject to the alternative set of rules. Alternative sets of rules may be positioned on separate viewable sections from underwriting rules. In an embodiment, a plurality of viewable sections including underwriting rules and a plurality of alternative sets of rules may be used to analyze insurance information.

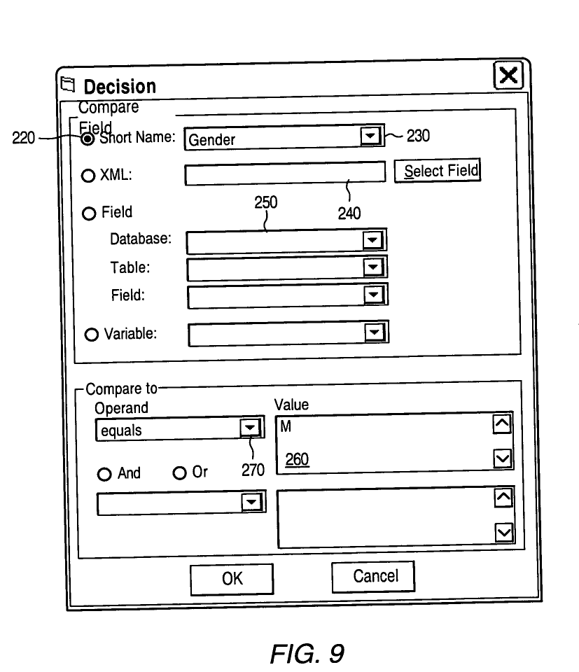

A toolbar on a drawing tool may include a decision icon. A decision icon may compare insurance information to a predetermined value and direct a flow of logic accordingly. A predetermined value may be entered by a user or have a pre-set value. Predetermined values may be influenced by business rules, industry standards, and/or state and federal regulations. FIG. 8 depicts an embodiment of a decision prompt displayed to a user when the user positions a decision icon on a viewable section. A decision prompt may include a template with one or more fields. A user creating underwriting rules may enter values in one or more fields of the decision template. A decision icon may compare a portion of a database and/or XML message to a predetermined value. One field may include the name of the decision to be made. A decision icon may compare a first field to a second field. A user may enter a database field, XML message, or variable as in a field of the input window. A user may enter one or more values in another field of the input window, such that a database field, XML message, or variable is compared to the value in the other field of the input window. An input window may include several options regarding how to compare fields in the input window. Fields may be compared based on number, strings of numbers, characters, and/or other values.

For example, a user may label an icon ‘gender.’ A user may select a field of a database containing the gender of a driver to input into a field of the input window. A user may also enter ‘female’ into another field of the input window. When the decision icon labeled gender processes insurance information, the gender of a driver from the field of a database will be compared to female, the value entered in the other field of the input window. Connecting icons may indicate which path of the rules sequence to follow based on whether the output from the gender icon is true or false.

A decision prompt may automatically supply options to a user deciding what value to enter into fields of a decision prompt. For example, a decision prompt field may automatically include database fields linked to a drawing tool. A decision prompt may automatically include XML message fields linked to a drawing tool. In certain embodiments, a decision prompt may automatically include previously used values, and/or common industry values for a predetermined value. A user may select from automatically included values for a field of a decision prompt or enter a different value into a field of a decision prompt.

A return icon may be used in a drawing tool. A return icon may have a shape similar to a “U” shaped arrow. A return icon may be used to produce values as an output or report. A return icon may return values to a user or an insurance processing system as an XML message or XML document. A return icon may return values as one or more fields in a database. A return icon may transmit values to a user. A return icon may transmit values to a computer system, such as a user system or an insurance processing system.

In some embodiments, a user may select a start icon from the toolbar in the drawing tool and place the start icon on a viewable window, as depicted in FIG. 6. A user may give a name to the viewable window, such as ‘automobile insurance.’ A user may then select a decision icon from the toolbar and position it proximate the start icon. A decision window with a plurality of fields may prompt the user to input information.

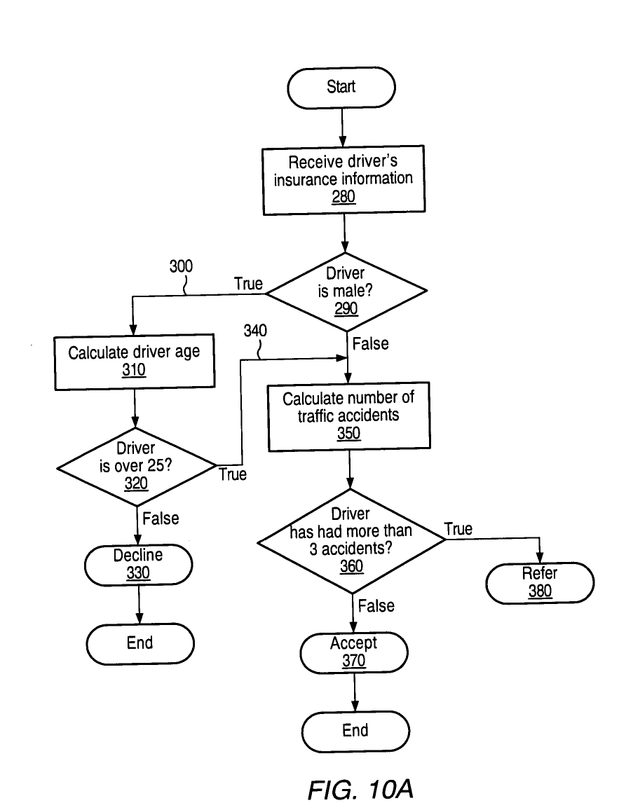

FIG. 9 depicts an embodiment of a decision prompt displayed to a user when the user positions a decision icon on a viewable section or rules viewable section of a drawing tool. A user may select or enter a name to be associated with the decision icon 220. A user may enter a name 230 to be associated with the decision icon in the decision prompt. The decision prompt may automatically supply options for names to the user in a field of the template. The name entered may be displayed on a viewable section proximate the decision icon. A decision prompt may include fields where a user can select or enter a portion of an XML message 240, field of a database 250, and or a variable to which the predetermined value 260 may be compared. A variable may include, but is not limited to, the result of calendar, calculate, or other icons. A user may also enter a predetermined value 260 to which a selected field of the template of the decision prompt may be compared. The decision icon functions may include, but are not limited to comparing values of the fields to determine whether fields are equal, one field is greater or less than another field, and/or one field is greater or less than a percentage of another field. A field of the decision icon may automatically supply possible functions or a user may input a function for a decision icon to follow 270. For example, a user may create a decision icon, named gender, to determine whether a field of a database 250, including the gender of an applicant, equals 270 a predetermined value, M, 260.

Two possible paths for a flow of logic exist from a decision icon, a true and a false path. When a decision icon in underwriting rules processes insurance information, a portion of the insurance information is compared to a predetermined value. The insurance information will either satisfy the condition fail to satisfy the condition in the decision icon. If the insurance information satisfies the condition in the decision icon, then the flow of logic will follow a ‘true’ path out of the decision icon. If the insurance information does not satisfy the condition in the decision icon, then the flow of logic will follow a ‘false’ path out of the decision icon.

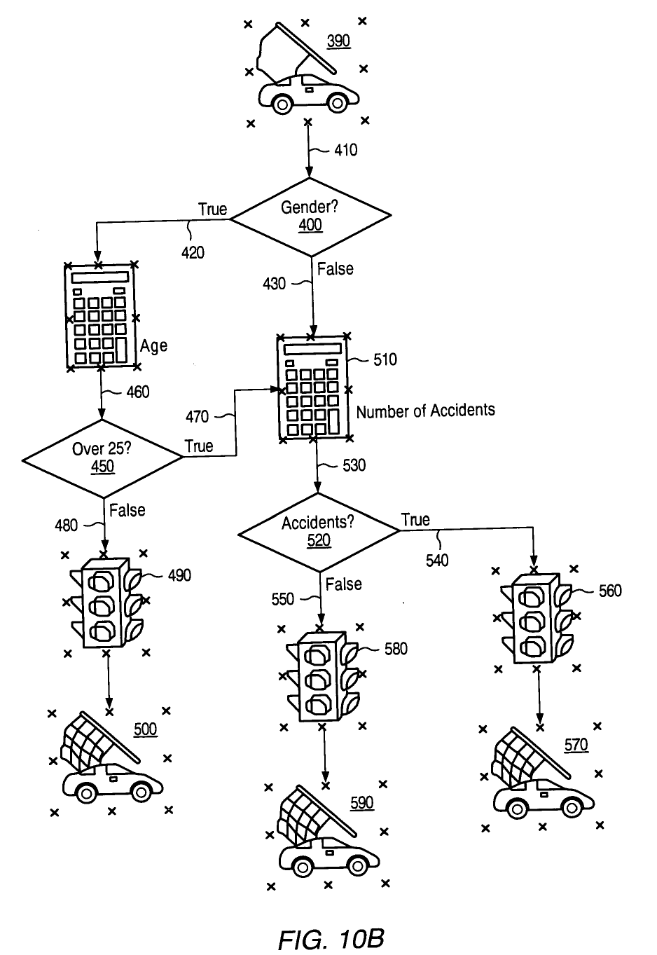

An embodiment of a simplified set of underwriting rules for automobile insurance is depicted as a flow chart in FIG. 10A. Underwriting rules may be based on business rules and/or industry customs. For example, if the industry generally declined all males under 25, referred all drivers over 25 with more than three accidents, and accepted all other applicants, a flowchart similar to FIG. 10A may depict the flow of logic. First a driver's insurance information is received 280. Insurance information may include, but is not limited to, gender, driving record, accident history, car make and model, age, and/or birth date. Next, the driver's insurance information is analyzed to determine if the driver is male 290. If the driver is male, then the true path of logic is followed 300. The driver's age is then calculated from insurance information 310. The driver's age is then compared to 25, the predetermined age, 320. If the driver is under 25, then the policy is automatically declined 330. If the driver is over 25, then the flow of logic is returned to the same step a female driver would follow 340. The number of total accidents the driver was involved in would then be calculated 350. Next, the number of total accidents the driver was involved in would be compared to a predetermined value (i.e., whether the driver has had more than three accidents) 360. If the driver has had less than three accidents the automobile policy would be automatically accepted 370. If the driver has had more than three accidents then the policy would be automatically referred to a human underwriter 380.

A user may create underwriting rules in a drawing tool. As depicted in FIG. 10B, a user may create underwriting rules in a drawing tool to represent a set of underwriting rules similar to the embodiment depicted in FIG. 10A. First, a user may select and position a start icon 390 on a worksheet. A user may then select and position a decision icon 400 on the worksheet. A user may name the decision icon 400 gender. A decision prompt may then be displayed to the user, such as a pop-up dialog box. A decision prompt may be configured to compare a first field to a first pre-determined value. A first field may be accessed from a field of a database or a portion of an XML message. A first pre-determined value may be entered based on industry standards, business practices, company policies, and/or federal regulations. According to the embodiment of underwriting rules depicted in FIG. 10A, a first pre-determined value of male is selected. The gender decision icon 400 may be-coupled 410 to the start icon 390, such that a flow of logic goes from the start icon to the gender decision icon. Two possible paths from the gender decision icon 400 exist, a true 420 and a false 430 path. The user may position a calculate icon 440 configured to determine a driver's age on the worksheet. The calculate icon 440 may be labeled age. The age calculation icon may calculate the driver's age based on a birth date and the current date. The user may couple the age calculation icon 440 to the gender decision icon 400 using a true 420 connector. The true connector 420 may direct the flow of logic for any application that produces a true result at gender decision icon 400 toward the age calculation icon 440.

Next, the user may select and position a decision icon 450 on the worksheet. The user may label the decision icon 450 “over 25.” A decision prompt may then be displayed to the user, such as a pop-up dialog box. A decision prompt may be configured to compare a second field to a second pre-determined value. A second field may be accessed from a field of a database or a portion of an XML message. A second pre-determined value may be entered based on industry standards, business practices, company policies, and/or federal regulations. According to an embodiment of underwriting rules depicted in FIG. 10A, a second pre-determined value of 25 is selected. The over 25 decision icon 450 may be coupled using a connector 460 to the age calculation icon 440, such that a flow of logic goes from the age calculation icon to the over 25 decision icon. Two possible paths from the over 25 decision icon 450 exist, a true 470 and a false 480 path. The user may select and position an output icon 490 representing declining the policy on the worksheet. The user may couple the decline output icon 490 to the over 25 decision icon 450 with a false connector 480, such that if the insurance information does not satisfy the over 25 decision icon, the policy is automatically declined by the decline output icon. The user may couple an end icon 500 to the decline output icon 490 such that the flow of logic terminates and a report and/or output is transmitted.

The user may select and position a calculate icon 510 on the worksheet. The calculate icon 510 may be labeled number of accidents. The number of accidents icon 510 may be configured to count the number of accidents in the insurance information related to a driver. The number of accidents icon 510 may be coupled to the gender decision 400 with a false 430 connector, such that if a driver is not male then the number of accidents for a driver is calculated regardless of the age of the driver. The number of accidents icon 510 may also be coupled to the over 25 decision icon 450 with a true 470 connector, such that if the over 25 decision icon is satisfied then the flow of logic may flow for male drivers to the number of accidents icon.

The user may then select and position a decision icon 520 on the worksheet and label the decision icon “accidents.” A decision prompt may then be displayed to the user, such as a pop-up dialog box. A decision prompt may be configured to compare a third field to a third pre-determined value. A third field may be accessed from a field of a database or a portion of an XML message. A third pre-determined valued may be entered based on industry standards, business practices, company policies, and/or federal regulations. According to an embodiment of underwriting rules depicted in FIG. 10A, a third pre-determined value of three accidents is selected. The accident decision icon 520 may be coupled using a connector 530 to the number of accidents icon 510, such that a flow of logic goes from the number of accidents icon to the accident decision icon.

Two possible paths from the accident decision icon 520 exist, a true 540 and a false 550 path. A user may select a refer output icon 560 from a toolbar and position the icon on the worksheet. The user may couple the refer output icon 560 to the accident decision icon 520 with a true 540 connector, such that if the condition in the accident decision icon is satisfied the flow of logic goes to the refer output icon. The user may position an end icon 570 on the worksheet and couple the end icon to the refer output icon 560, such that the flow of logic terminates and a report and/or output is transmitted. The user may select and position an accept output icon 580. A user may couple the accept output icon 580 to the accident decision icon 520 using a false 550 connector, such that if insurance information does not satisfy the conditions of the accident decision icon then the flow of logic goes to the accept output icon. The user may position an end icon 590 on the worksheet and couple the end icon to the accept output icon 580, such that the flow of logic terminates and a report and/or output is transmitted.

Once underwriting rules or a graphical model of the underwriting rules are created on a drawing tool, the underwriting rules may be transmitted to an insurance processing system. The underwriting rules may be stored on a memory and/or database of the insurance processing system. Underwriting rules may be executable by an insurance processing system. The underwriting rules or graphical model may be automatically converted into an executable insurance underwriting computer program. The underwriting computer program may apply the modeled underwriting rules to the analysis of insurance underwriting data. In some embodiments, analyzing insurance underwriting data includes receiving insurance information, accessing the insurance underwriting computer program, and automatically determining the underwriting status of the received insurance information using the insurance underwriting computer program. Analyzing insurance information using underwriting rules may determine under which type of insurance product an applicant may be accepted. In one embodiment, analyzing insurance information using underwriting rules may determine under which insurance product rating program an insurance application may be accepted. A report may be produced that includes the result of the analysis of insurance underwriting data or insurance information and/or the reason for the result.

A user may access an insurance processing system to process insurance information stored on a memory or database of an insurance processing system. A user may transmit XML messages to an insurance processing system and the insurance processing system may process XML messages according to underwriting rules stored on a memory. In certain embodiments, underwriting rules may be stored on a memory of a user system. Underwriting rules may be executable by the user system. A user may process insurance information stored on a database or memory using the underwriting rules.

In some embodiments, underwriting rules may be configured to produce an output or report. An output or report may include a business decision, such as whether to accept, decline or refer an insurance policy application. An output or report may include a business decision, such as risk involved with accepting a policy, reasons for accepting a policy, etc. An output or report may be a message, such as an XML message or file. An output may include underwriting status from processing insurance information using underwriting rules including, but not limited to, accepting a policy or claims; declining a policy or claim; referring a policy or claim; and/or reasons for accepting, declining, or referring a policy or claim. The underwriting status may include under which type of insurance product an insurance applicant should be accepted. Insurance companies may offer several types of insurance products. Insurance products may include multiple rating schedules including, but not limited to, standard, sub-standard, and/or premium. Underwriting guidelines may determine under which program or tier an accepted policy may be accepted or rated. Rating schedules may affect insurance premiums. The underwriting status may include under which insurance product rating program or tier a policy application may be accepted. For example, a report may include information such as return “ACCEPTED—PREMIUM” or “ACCEPTED—STANDARD.” The output or report produced by underwriting rules may include a numerical score or tally. Underwriting rules may calculate a numerical score based on the analysis of insurance information (e.g., a number representing the risk to the company if it issues the policy). In an embodiment, the underwriting rules may automatically accept policies with a score lower than a predetermined value, automatically decline policies with a score above a predetermined value, and refer all other policies. In one embodiment, a report may include information such as “DECLINED—application has a male driver, John Doe, who at age 16 and with 9 points off his license, does not meet the underwriting guidelines of XYZ Insurance Company.”

In some embodiments, a report may be defined by a user, the insurance processing system, and/or the underwriting rules. A user may determine what information is included in a report or an output. A user may input or request specific information, such as underwriting status, to be included in a report. A user may select information included in a report or output from options available in a specific underwriting program. In an embodiment, underwriting rules may receive a request from the user system that includes what information a user desires in a report and return a report to the user system with at least the information a user requested to be included. In certain embodiments, underwriting rules may determine what information may be included in a report or output. Underwriting rules may determine what information may be included in a report based on: the insurance company for which an application is being processed, the user requesting the information analysis by the underwriting rules, the type of insurance requested by the applicant, the applicant, and/or predetermined criteria within the underwriting rules. In one embodiment, an insurance processing system may determine what information including underwriting status may be included in a report.

A drawing tool may include a program or subroutine configured to facilitate debugging underwriting rules. The debugging program may facilitate the identification of errors in underwriting rules and/or problems with the flow of logic in underwriting rules. The debug program may allow a user to view how information is processed by each step of a set of underwriting rules. In some embodiments, a user may create a filtered document that does not contain unnecessary information from a database being accessed by underwriting rules. In some embodiments, when the debugging program is executed a data prompt may allow a user to enter a data source. The data prompt may include fields that allow a user to enter a database or XML message as a source of data; one or more filters to sort the data; and/or one or more response documents, where the response document may include information created as a result of executing underwriting rules. A debugging program may include a feature that allows a user to check if data from an XML message and/or database are accessed properly. An error message may indicate if the data is inaccessible or an error occurs while retrieving data. The debugging program may include a viewable section that displays each step and/or result of each step of underwriting rules according to the flow of logic through the underwriting rules. A debug program may allow a user view the results of information processed by each step of underwriting rules stepwise.

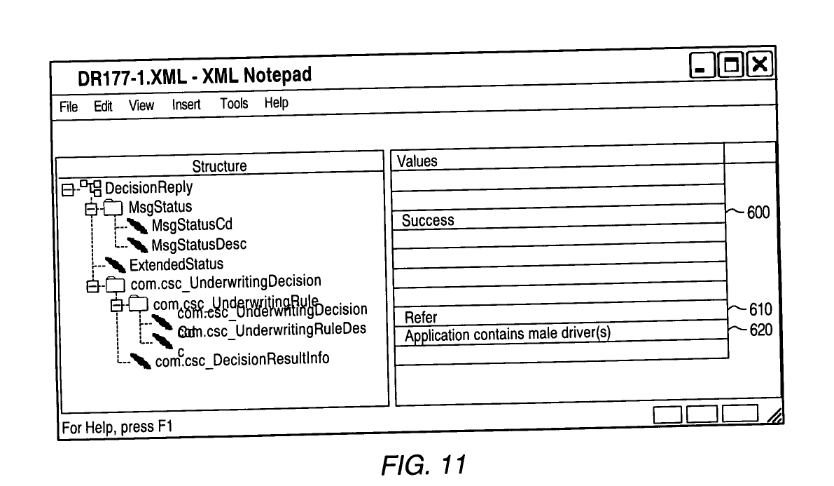

A debug program may allow a user to view the results of analyzing data using the underwriting rule. FIG. 11 depicts an embodiment of a result report produced by the debugging program. A result report may include whether a runtime error occurred 600. A result report may include whether an insurance claim or policy would be accepted, declined, or referred 610 as a result of the execution of underwriting rules. A result report may include one or more reasons a policy was accepted, declined, or referred 620.

In some embodiments, a debugging program may execute underwriting rules and display the number of errors encountered in executing the underwriting rules. For example, a user may create underwriting rules and run a debugging program. The debugging program may produce an output displaying the number of errors. A user may selectively view the errors encountered in executing the debugging program. In some embodiments, the debugging program may suggest or automatically correct errors encountered when executing underwriting rules.

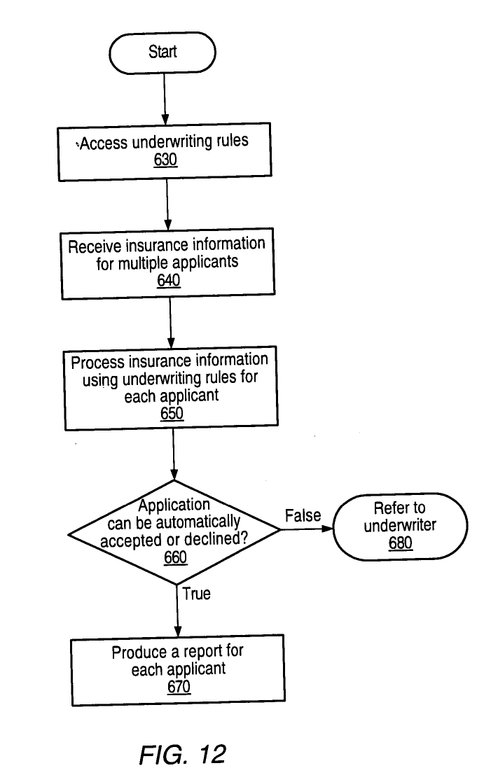

In various embodiments, the insurance information may be imported in batches (e.g., policy information may be analyzed each night) and/or continuously. For example, insurance information may be batch or continuously processed by an insurance processing system in a manner similar to the flowchart depicted in FIG. 12. An insurance processing system may access underwriting rules stored in a memory or database 630. The underwriting rules may have been created by a user and transmitted to the insurance processing system and/or at least partially created on the insurance processing system. Next, the insurance processing system receives insurance information from multiple applicants 640 via databases and/or XML messages. A data transformer may covert received data into a format that the underwriting rules are capable of processing. The insurance processing system analyzes all the received insurance information using the underwriting rules stored in a memory of the insurance processing system 650. If any application can be automatically accepted or declined 660, then a report is produced for each applicant and/or policy 670. The report may include whether an application is accepted or declined, why an application is accepted or declined, and/or under which insurance products an applicant may be accepted. The report may be transmitted to the user who sent insurance information to the insurance processing system for analysis. If an application can not be automatically accepted or declined 660, then it may be refereed to a human underwriter 680.

In some embodiments, insurance information may be imported in real-time. A user may transmit insurance information for analysis by underwriting rules. For example, as a policy is requested, the data may be analyzed, assessed, and communicated to the user taking the policy request in real-time. An estimated policy price also may be transmitted to the user taking the policy request. Results of the underwriting rules assessment may be an output or report that is transmitted to database in an insurance processing system. An output or report may be transmitted to the user system that sent the insurance information to be processed by the underwriting rules. The report may include whether an application is accepted or declined, why an application is accepted or declined, and/or under which insurance products an applicant may be accepted.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link. In some embodiments, an insurance processing system may include a CPU and a memory coupled to the CPU. An insurance processing system memory may store programs that may be at least partially executed by the CPU of an insurance processing system. The program instructions may include receiving insurance information and processing the insurance information according to underwriting rules stored on a memory of an insurance processing system.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of automatically underwriting insurance policies comprising:
accessing a drawing program;
creating a graphic model of one or more business rules used to underwrite insurance policies using the drawing program;
automatically converting the graphic model of the underwriting rules into an executable insurance underwriting computer program capable of applying the modeled underwriting rules to the analysis-of insurance underwriting data;
analyzing insurance underwriting data using the insurance underwriting computer program; and
producing a report, wherein the report comprises the result of the analysis of the insurance underwriting data.

2. The method of claim 1, wherein the drawing program is configured to perform a modeling method comprising:
displaying one or more screens on a computer monitor;
displaying one or more icons on a computer monitor, wherein one or more icons are positionable in one or more screens;

3. The method of claim 2, wherein creating a graphic model of one or more business rules comprises positioning one or more icons on one or more screens on a computer monitor; and forming one or more connections between the icons on the screen, wherein the connections model the business rules process flow.

4. The method of claim 2, wherein creating a graphic model of one or more business rules comprises associating one or more data sources to one or more icons, wherein the one or more data sources comprise insurance underwriting data for analysis by the underwriting computer program.

5. The method of claim 1, wherein accessing a drawing program comprises accessing the drawing program through a user system from an insurance processing system across a network via one or more Internet protocols.

6. The method of claim 1, further comprising:
modifying the graphical model of one or more business rules using the drawing program; and
converting the modified graphic model of the underwriting rules into an executable insurance underwriting computer program.

7. The method of claim 6, wherein modifying the graphical model of one or more business rules comprises adding or removing one or more icons to a graphical display of the graphical model using the drawing program.

8. The method of claim 1, wherein automatically converting the graphic model of the underwriting rules into an executable insurance underwriting computer program comprises preparing a business rules document that includes computer readable data that corresponds to the modeled business rules.

9. The method of claim 7, wherein the business rules document comprises an XML language document.

10. The method of claim 7, further comprising transmitting the business rules document to an insurance processing system, wherein the insurance processing system is configured to convert the business rules document into an executable insurance underwriting computer program.

11. The method of claim 1, wherein analyzing insurance underwriting data using the insurance underwriting computer program comprises:
receiving insurance underwriting data;
accessing the insurance underwriting computer program; and
automatically determining the underwriting status of the received insurance underwriting data using the insurance underwriting computer program.

12. The method of claim 11, wherein the insurance underwriting data is received as an XML message.

13. The method of claim 11, wherein the insurance underwriting data is received from a user system database.

14. The method of claim 11, wherein the insurance underwriting data is received from an insurance system database.

15. A carrier medium comprising program instructions, wherein the program instructions are executable to implement:
accessing a drawing program;
creating a graphic model of one or more business rules used to underwrite insurance policies using the drawing program;
automatically converting the graphic model of the underwriting rules into an executable insurance underwriting computer program capable of applying the modeled underwriting rules to the analysis of insurance underwriting data;
analyzing insurance underwriting data using the insurance underwriting computer program;
producing a report, wherein the report comprises the result of the analysis of the insurance underwriting data.

16. The carrier medium of claim 15, wherein the drawing program is configured to perform a modeling method comprising:
displaying one or more screens on a computer monitor;
displaying one or more icons on a computer monitor, wherein one or more icons are positionable in one or more screens;

17. The carrier medium of claim 16, wherein creating a graphic model of one or more business rules comprises positioning one or more icons on one or more screens on a computer monitor; and forming one or more connections between the icons on the screen, wherein the connections model the business rules process flow.

18. The carrier medium of claim 16, wherein creating a graphic model of one or more business rules comprises associating one or more data sources to one or more icons, wherein the one or more data sources comprise insurance underwriting data for analysis by the underwriting computer program.

19. The carrier medium of claim 15, wherein accessing a drawing program comprises accessing the drawing program through a user system from an insurance processing system across a network via one or more Internet protocols.

20. The carrier medium of claim 15, wherein the program instructions are further computer-executable to implement:
modifying the graphical model of one or more business rules using the drawing program; and
converting the modified graphic model of the underwriting rules into an executable insurance underwriting computer program.

21. The carrier medium of claim 20, wherein modifying the graphical model of one or more business rules comprises adding or removing one or more icons to a graphical display of the graphical model using the drawing program.

22. The carrier medium of claim 20, wherein automatically converting the graphic model of the underwriting rules into an executable insurance underwriting computer program comprises preparing a business rules document that includes computer readable data that corresponds to the modeled business rules.

23. The carrier medium of claim 21, wherein the business rules document comprises an XML language document.

24. The carrier medium of claim 21, wherein the program instructions are further computer-executable to implement transmitting the business rules document to an insurance processing system, wherein the insurance processing system is configured to convert the business rules document into an executable insurance underwriting computer program.

25. The carrier medium of claim 15, wherein analyzing insurance underwriting data using the insurance underwriting computer program comprises:
receiving insurance underwriting data;
accessing the insurance underwriting computer program; and
automatically determining the underwriting status of the received insurance underwriting data using the insurance underwriting computer program.

26. The carrier medium of claim 25, wherein the insurance underwriting data is received as an XML message.

27. The carrier medium of claim 25, wherein the insurance underwriting data is received from a user system database.

28. The carrier medium of claim 25, wherein the insurance underwriting data is received from an insurance system database.

29. An insurance processing system comprising:
a CPU;
a memory coupled to the CPU, wherein the memory comprises program instructions executable to implement:
accessing a drawing program;
creating a graphic model of one or more business rules used to underwrite insurance policies using the drawing program;
automatically converting the graphic model of the underwriting rules into an executable insurance underwriting computer program capable of applying the modeled underwriting rules to the analysis of insurance underwriting data;
analyzing insurance underwriting data using the insurance underwriting computer program;
producing a report, wherein the report comprises the result of the analysis of the insurance underwriting data.

30. The system of claim 29, wherein the drawing program is configured to perform a modeling method comprising:
displaying one or more screens on a computer monitor;
displaying one or more icons on a computer monitor, wherein one or more icons are positionable in one or more screens;

31. The system of claim 30, wherein creating a graphic model of one or more business rules comprises positioning one or more icons on one or more screens on a computer monitor; and forming one or more connections between the icons on the screen, wherein the connections model the business rules process flow.

32. The system of claim 30, wherein creating a graphic model of one or more business rules comprises associating one or more data sources to one or more icons, wherein the one or more data sources comprise insurance underwriting data for analysis by the underwriting computer program.

33. The system of claim 29, wherein accessing a drawing program comprises accessing the drawing program through a user system from an insurance processing system across a network via one or more Internet protocols.

34. The system of claim 29, wherein the program instructions are further computer-executable to implement:
modifying the graphical model of one or more business rules using the drawing program; and
converting the modified graphic model of the underwriting rules into an executable insurance underwriting computer program.

35. The system of claim 34, wherein modifying the graphical model of one or more business rules comprises adding or removing one or more icons to a graphical display of the graphical model using the drawing program.

36. The system of claim 34, wherein automatically converting the graphic model of the underwriting rules into an executable insurance underwriting computer program comprises preparing a business rules document that includes computer readable data that corresponds to the modeled business rules.

37. The system of claim 35, wherein the business rules document comprises an XML language document.

38. The system of claim 35, wherein the program instructions are further computer-executable to implement transmitting the business rules document to an insurance processing system, wherein the insurance processing system is configured to convert the business rules document into an executable insurance underwriting computer program.

39. The system of claim 29, wherein analyzing insurance underwriting data using the insurance underwriting computer program comprises:
receiving insurance underwriting data;
accessing the insurance underwriting computer program; and
automatically determining the underwriting status of the received insurance underwriting data using the insurance underwriting computer program.

40. The system of claim 39, wherein the insurance underwriting data is received as an XML message.

41. The system of claim 39, wherein the insurance underwriting data is received from a user system database.

42. The system of claim 39, wherein the insurance underwriting data is received from an insurance system database.
